(19) United States
(12) Patent Application Publication
(10) Pub. No.: US 2024/0286302 A1
(43) Pub. Date: Aug. 29, 2024

(54) Pet Hair Trim Clipper

(71) Applicant: Shuiyou Zeng, Lufeng Shanwei City (CN)

(72) Inventor: Shuiyou Zeng, Lufeng Shanwei City (CN)

(21) Appl. No.: 18/238,539

(22) Filed: Aug. 28, 2023

(30) Foreign Application Priority Data
Feb. 28, 2023 (CN) 202330082121.5
Mar. 2, 2023 (CN) 2023203701775
Apr. 4, 2023 (CN) 202330179162.6

(51) Int. Cl. B26B 19/24; A01K 13/00; B26B 19/02; B26B 19/44

(52) U.S. Cl. CPC B26B 19/24; A01K 13/00; B26B 19/02; B26B 19/44

(57) ABSTRACT

A pet hair trim clipper includes a main clipper body and a handle connected to the main clipper body, wherein the main clipper body includes at least one longitudinal trim cutter for trimming the pet hair and a hair removing element for scraping down the hair on the longitudinal trim cutter, wherein a trimming direction of the longitudinal trim cutter is perpendicular to a longitudinal direction of the handle, so as to facilitate the use.

### CROSS REFERENCE OF RELATED APPLICATION

This application is a non-provisional application that claims priority under 35 U.S.C. § 119 to China application number CN202320370177.5, filing date Mar. 2, 2023, China application number CN202330082121.5, filing date Feb. 28, 2023, and China application number CN202330179162.6, wherein the entire content of which is expressly incorporated herein by reference.

### BACKGROUND OF THE PRESENT INVENTION

### Field of Invention

The present invention relates to the technical field of pet hair grooming device, and more particularly to a pet hair trim clipper.

### Description of Related Arts

Pets refer to organisms that people raise for spiritual purposes rather than economic purposes. Traditional pets refer to mammals or birds that are kept for play and companionship. In actual life, pets such as fish, reptiles, amphibians, and insects, are used for viewing, companionship, and relieving people's mental stress. With the development of the times, the scope of pets is very broad, comprising animals, plants, virtual pets, electronic pets, etc. However, the laws of most countries still limit pets to the category of animals. Keeping pets as an opportunity for humans to get close to nature can satisfy human psychological needs and is a very healthy and normal hobby. In order to maintain the physical health of pets, their fur needs to be trimmed during hot weather.

After trimming the pet hair, a conventional pet hair trimming comb generally requires manual operation to removed the combed hair from the comb, and then discard the combed hair into the trash can. During the removal process, the pet hair will scatter everywhere, resulting in a large amount of pet hair in the environment, which affects people's normal life. At the same time, most trimming combs adopts a single-row-brush structure to trim the hair on the pet's body, it takes a relatively long time to adjust a position of the pet or a position of the user for scraping and combing. Long-term combing not only increases the labor intensity of people, but also for most pets, long-term combing will gradually make the pets lose patience, become irritable and impatient, and even cause harm to humans.

In addition, referring to FIG. 1 of the drawings, a conventional pet hair trimming comb generally comprises a trimming portion 101 and a handle portion 102 extended from the trimming portion 101, the trimming portion 101 has a trimming blade 103 which is extended along a direction that is perpendicular to an extending direction of the handle portion 102, so that when the pet is lying in front of the user, the user has to adjust his or her wrist so as to align the handle portion 102 along a length of the pet, and repeated trimming operations by the trimming blade 103 requires the wrist of the user to be kept in in an unnatural twisted state, so that the hand of the user is easy to get tired.

Furthermore, the trimming operation by the trimming blade 103 should be carried out in a manner complying with the layout of the coat of the pet. However, the pet may be lying in front of the user in a random direction, and the user may be required to change his or her holding hand for holding the conventional comb, so as to adjust the trimming direction of the trimming blade 103 which is suitable for the lying direction of the pet.

### SUMMARY OF THE PRESENT INVENTION

An object of the present invention is to provide a pet hair trim clipper to solve the problems mentioned in the above description of related arts.

To achieve the above objectives, an aspect of the present invention provides the following technical solution by a pet hair trim clipper comprising a main clipper body and a handle fixedly connected to a bottom of the main clipper body, two sets of trimmer members are arranged on a front of the main clipper body, a hair removing element which can be a plate is arranged on the front of the main clipper body, two sets of slots are formed at the front side of the hair removing element for the trimmer members to pass through the inner cavity of the slots, a button slot is formed on a back of the main clipper body, a pressing button is arranged in the inner cavity of the button slot, a connecting rod is arranged in the inner cavity of the main clipper body, a reset spring is arranged on the outer circumference of the connecting rod, an air duct slot is form at the front side of the main clipper body, a second slot is opened at the front side of the hair removing element, and an anti-slip pattern is arranged on a back of the pressing button.

Preferably, the handle is a hollow tube, and the inner cavity of the handle is in communication with the main clipper body.

Preferably, the second slot is in communication with the air duct slot, and the air duct slot is in communication with the inner cavity of the main clipper body.

Preferably, the connecting rod passes through the inner cavity of the main clipper body and is connected to the hair removing element, and the back of the connecting rod is connected to the pressing button.

Preferably, the outer side of the handle is equipped with a sheath which is equipped with a second anti-slip pattern.

Preferably, the front of the main clipper body is provided with an installation groove, and the inner cavity of the installation groove is provided with an installation block, and the trimmer members are connected to the installation block.

Preferably, there are fixing holes in both side portions of the main clipper body, and the inner cavity of the fixing holes are equipped with fixing bolts. The fixing bolts pass through the installation groove and penetrating through the installation block.

Preferably, the front side of the hair removing element is provided with a second fixing hole, and the inner cavity of the second fixing hole is provided with a connecting bolt. The front side of the connecting rod is provided with a connecting screw hole, and the connecting bolt passes through the second fixing hole to reach to the connecting screw hole.

Compared with the prior art, the advantageous effect of the present invention is as follows.

First of all, the pet hair trim clipper employs the handle, the trimmer members, the hair removing element, the slot, the pressing button, the connecting rod, the reset spring, the air duct groove, and the cooperation of a second slot. After hair trimming, the hair will hang on the trimmer members. The vacuum cleaner hose is connected to the handle, and the pressing button is pressed to drive the hair removing element to move forward by the connecting rod to remove the pet hair hang on the trimmer members that pass through the slot. Activating the vacuum cleaner allows the pet hair to enter the air duct groove from the second slot and finally be sucked into the vacuum cleaner through the handle, achieving the purpose of quickly removing and collecting pet hair, and solving the problem of difficult and quick treatment of pet hair with conventional pet hair trim combs.

Secondly, the pet hair trim clipper adopts the use of the fixing holes, the second fixing hole, the fixing bolts, the connecting screw hole, and the connecting bolt. When the main clipper body is used for a long time and the trimmer members may be damaged, the connecting bolt in the second fixing hole can be unscrewed from the connecting screw hole, and then the hair removing element can be separated from the connecting rod, so that the hair removing element can be taken out. Then, the fixing bolts in the fixing holes can be removed, and the installation block can be taken out from the installation groove. At this time, the trimmer members can be disassembled, achieving the purpose of convenient replacement of the trimmer members.

Another advantage of the present invention is to provide a pet hair trim clipper, wherein the main clipper body comprises at least one longitudinal trim cutter which is extended along a direction along a longitudinal direction of the handle, so as to facilitate the user to hold on the handle to carry out the hair trimming operations.

Another advantage of the present invention is to provide a pet hair trim clipper, wherein a hair trimming direction of the longitudinal trim cutter is perpendicular to a longitudinal extending direction of the handle, so that the user can naturally hold on the handle for the hair trimming operations on the pet which is in front of the user.

Another advantage of the present invention is to provide a pet hair trim clipper, wherein the main clipper body comprises two longitudinal trim cutters which allow the user to trim and groom the pet hair in two opposite hair trimming directions, so that when the pet is standing, sitting or lying in front of the user with its body extending in a random direction, the user is able to trim the pet hair with the pet hair trim clipper of the present invention.

Another advantage of the present invention is to provide a pet hair trim clipper, wherein no matter the extending direction of the pet body, there is no need for the user to change his or her holding hand for implementing the trimming operations while allowing the hair trimming direction to be complying with the layout direction of the coat of the pet which is the direction of hair growth.

Another advantage of the present invention is to provide a pet hair trim clipper, wherein by a relative movement between a hair removing element and the longitudinal trim cutters, the hair, which is cutting down from the pet, hanging on the longitudinal trim cutters can be scraped down from the longitudinal trim cutters by the hair removing element.

Another advantage of the present invention is to provide a pet hair trim clipper, wherein the hair cut down by the longitudinal trim cutters can be vacuum sucked into a detachable vacuum device or an integral vacuum assembly incorporated into the pet hair trim clipper, so that the hair can be removed from the main clipper body immediately.

Another advantage of the present invention is to provide a pet hair trim clipper, wherein a vacuum adjusting hole is formed in the main clipper body or the handle for communicating with an air duct in the pet hair trim clipper, so that during the hair removing operations, the vacuum adjusting hole can be gradually opened or closed to change the air pressure in the air duct, so that the hair residual on the longitudinal trim cutters is more easily to be sucked into the pet hair trim clipper.

Additional advantages and features of the invention will become apparent from the description which follows, and may be realized by means of the instrumentalities and combinations particularly pointing out in the appended claims.

According to the present invention, the foregoing and other objects and advantages are attained by a pet hair trim clipper, comprising a main clipper body and a handle connected to the main clipper body, wherein the main clipper body comprises at least one longitudinal trim cutter for trimming the pet hair.

According to an embodiment of the present invention, a trimming direction of the at least one longitudinal trim cutter is perpendicular to a longitudinal direction of the handle.

According to an embodiment of the present invention, the main clipper body comprises a trim assembly and a hair removing assembly, wherein the trim assembly comprises two longitudinal trim cutters, wherein the hair removing assembly and the trim assembly are configured to allow a relative movement therebetween, so as to allow the hair removing assembly to scrape down the pet hair on the two longitudinal trim cutters.

According to an embodiment of the present invention, the hair removing assembly comprises a hair removing element, an actuator, and a driving element, wherein the driving element comprises a connecting member connected to the actuator, and a reset member, wherein when the actuator is operated, the connecting member is driven to move, so as to drive the hair removing element to move with respect to the two longitudinal trim cutters, wherein when the actuator is released, the reset member reset the actuator, the connecting member and the hair removing element.

According to an embodiment of the present invention, the hair removing element comprises a moving sleeve which comprises a pusher end portion, wherein the trim assembly has a central slot for allowing the pusher end portion to penetrate therethrough to slide between the two longitudinal trim cutters for scraping down the pet hair on the two longitudinal trim cutters.

According to an embodiment of the present invention, the moving sleeve has a sleeve chamber and a suction opening communicated to the sleeve chamber, wherein the handle has a handle chamber which is communicated to the sleeve chamber of the moving sleeve to form an air duct.

According to an embodiment of the present invention, the pusher end portion of the hair removing element comprises a pusher edge which is circular in shape, wherein each of the two longitudinal trim cutters comprises a plurality of trim members and having a plurality of gaps between two adjacent trim members, wherein each of the trim members comprises two cutting edges and an end edge extended between the two cutting edges, wherein the hair removing element is configured to be moved to allow the pusher edge to be moved to a position corresponding to the end edges of the trim members of the two longitudinal trim cutters to scrape down the pet hair on the two longitudinal trim cutters.

According to an embodiment of the present invention, each of the two longitudinal trim cutters comprises two side edges, wherein the trim members are arranged between the two side edges, wherein each of the two side edges comprises an arc end edge portion.

According to an embodiment of the present invention, the hair removing element further comprises a mounting member connected to the moving sleeve, wherein the mounting members comprises a mounting plate and a mounting tube extended from the mounting plate for mounting the connecting member, wherein the connecting members comprises a lower connecting portion and an upper connecting portion which is integrally extended form the lower connecting portion, wherein the lower connecting portion of the connecting member is connected to the mounting tube, the upper connecting portion of the connecting member is connected to the actuator, wherein the lower connecting portion has a diameter that is smaller that a diameter of the upper connecting portion, wherein the reset member is wound around the lower connecting portion of the connecting member.

According to an embodiment of the present invention, the driving element further comprises a guiding member which is a guiding tube for guiding and restricting a sliding movement of the connecting member, wherein the rest member is assembled in the guiding member.

According to an embodiment of the present invention, the main clipper body further comprises a clipper housing, wherein the trim assembly is connected to the clipper housing, wherein an air duct is formed in the main clipper body and the handle, wherein the clipper body has a vacuum adjusting hole communicated to the air duct.

According to an embodiment of the present invention, the hair removing assembly comprises a hair removing element, an actuator, and a driving element, wherein the driving element comprises a connecting member connected to the actuator, and a reset member, wherein the removing element has a vent hole communicated to the air duct and the vent hole is aligned with the vacuum adjusting hole, wherein when the actuator is pressed, the connecting member is driven to move, so as to drive the hair removing element to move with respect to the two longitudinal trim cutters and the vent hole of the hair removing element is moved to a position that is not aligned with the vacuum adjusting hole, wherein when the actuator is released, the reset member reset the actuator, the connecting member and the hair removing element, and the vent hole is restored to be aligned with the vacuum adjusting hole.

According to an embodiment of the present invention, the hair removing assembly further comprises a cover portion having a connecting hole that is aligned with the vent hole, wherein when the actuator is pressed, the cover portion is fitted to the clipper housing to block the vacuum adjusting hole.

According to an embodiment of the present invention, the main clipper body further comprises a clipper housing, wherein the trim assembly is connected to the clipper housing, wherein the hair removing assembly comprises a hair removing element which comprises a hair removing plate having two slots, wherein the clipper housing is configured to be moved to direct the two longitudinal trim cutters to pass through the two slots in the hair removing plate respectively for trimming the pet hair.

According to an embodiment of the present invention, the hair removing element further comprises a supporting sleeve, wherein the clipper housing is slidably coupled to the supporting sleeve in a manner that when the clipper housing is pressed, the clipper housing is driven to slide along an outer side of the supporting sleeve, so as to drive the two longitudinal trim cutters to pass through the two slots in the hair removing plate respectively.

According to an embodiment of the present invention, the main clipper body further comprises a clipper housing connected to the handle for mounting the two longitudinal trim cutters, wherein the hair removing assembly comprises a hair removing element and an actuator which is mounted to the handle, wherein the actuator is pressed to drive the hair removing element to move with respect to the two longitudinal trim cutters for scraping down the hair on the two longitudinal trim cutters.

According to an embodiment of the present invention, the pet hair trim clipper further comprises a vacuum machine which comprises a machine body and a connecting pipe, wherein the connecting pipe is detachably connected to the handle.

According to an embodiment of the present invention,, the pet hair trim clipper further comprises a suction assembly connected to the handle.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a conventional pet hair trim comb.

FIG. 2 is a perspective view of a pet hair trim clipper according to a first preferred embodiment of the present invention.

FIG. 3 is a side sectional view of the pet hair trim clipper according to the above first preferred embodiment of the present invention.

FIG. 4 is a cross sectional view of the pet hair trim clipper according to the above first preferred embodiment of the present invention.

FIG. 5 is a partially enlarged view of area A of FIG. 4.

FIG. 6 is a partially enlarged view of area B of FIG. 2.

FIG. 7 is a perspective view of a pet hair trim clipper according to a second preferred embodiment of the present invention.

FIG. 8 is another perspective view of the pet hair trim clipper according to the above second preferred embodiment of the present invention.

FIG. 9 is a sectional view of the pet hair trim clipper according to the above second preferred embodiment of the present invention.

FIG. 10 is an exploded view of the pet hair trim clipper according to the above second preferred embodiment of the present invention.

FIG. 11 is a further exploded view of the pet hair trim clipper according to the above second preferred embodiment of the present invention.

FIG. 12 is another further exploded view of the pet hair trim clipper according to the above second preferred embodiment of the present invention.

FIG. 13 is a perspective view of a trim assembly of the pet hair trim clipper according to the above second preferred embodiment of the present invention.

FIG. 14 is another perspective view of the trim assembly of the pet hair trim clipper according to the above second preferred embodiment of the present invention.

FIG. 15 is a partially enlarged view of area C of FIG. 14.

FIG. 16A is a schematic view illustrating the operation of pressing an actuator for driving a hair moving element to move downward to scrape down the cut hair on two longitudinal trim cutters of the pet hair trim clipper according to the above second preferred embodiment of the present invention.

FIG. 16B is an enlarged sectional view illustrating the actuator of the pet hair trim clipper being in an idle state according to the above second preferred embodiment of the present invention.

FIG. 16C is an enlarged sectional view illustrating the actuator of the pet hair trim clipper being in an actuated state in which the actuator is pressed for driving the hair moving element to move downward to scrape down the cut hair on the two longitudinal trim cutters of the pet hair trim clipper according to the above second preferred embodiment of the present invention.

FIG. 17 is a perspective view illustrating the pet hair trim clipper being in a use sate for trimming the pet hair in a rightward trimming direction according to the above second preferred embodiment of the present invention.

FIG. 18 is a perspective view illustrating the pet hair trim clipper being in a use sate for trimming the pet hair in a leftward trimming direction according to the above second preferred embodiment of the present invention.

FIG. 19 is a sectional view illustrating a pet hair trim clipper according to a first alternative mode of the above second preferred embodiment of the present invention.

FIG. 20 is a perspective view illustrating the pet hair trim clipper being in a use sate for trimming the pet hair according to the above first alternative mode of the above second preferred embodiment of the present invention.

FIG. 21 is a perspective view illustrating a pet hair trim clipper according to a second alternative mode of the above second preferred embodiment of the present invention.

FIG. 22 is a perspective view illustrating the pet hair trim clipper being pressed to drive two longitudinal trim cutters to pass through two slots in a hair removing element for pet hair trimming according to the above second alternative mode of the above second preferred embodiment of the present invention.

FIG. 23 is a perspective view illustrating a pet hair trim clipper according to a third alternative mode of the above second preferred embodiment of the present invention.

FIG. 24 is a perspective view illustrating an actuator being pressed to drive a hair removing element to move to scrape down cut hair on the two longitudinal trim cutters of the pet hair trim clipper according to the above third alternative mode of the above second preferred embodiment of the present invention.

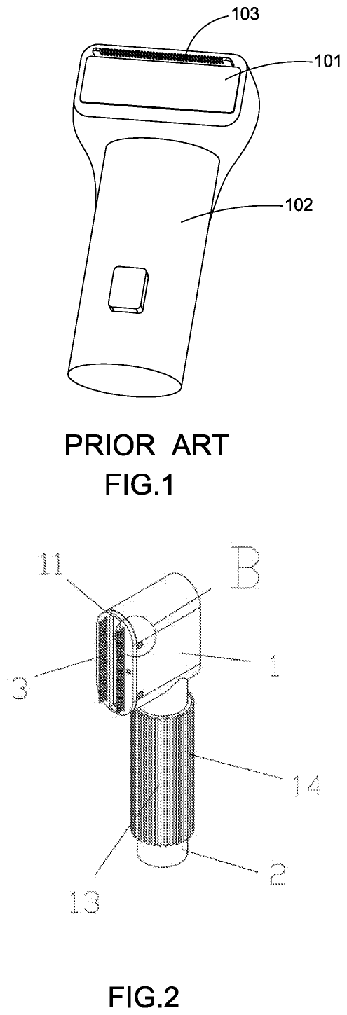

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back.” “left.” “right.” “perpendicular,” “horizontal,” “top.” “bottom,” “inner.” “outer,” and etc. that indicate relations of directions or positions are based on the relations of directions or positions shown in the appended drawings, which are only to facilitate descriptions of the present invention and to simplify the descriptions, rather than to indicate or imply that the referred device or element is limited to the specific direction or to be operated or configured in the specific direction. Therefore, the above-mentioned terminologies shall not be interpreted as confine to the present invention.

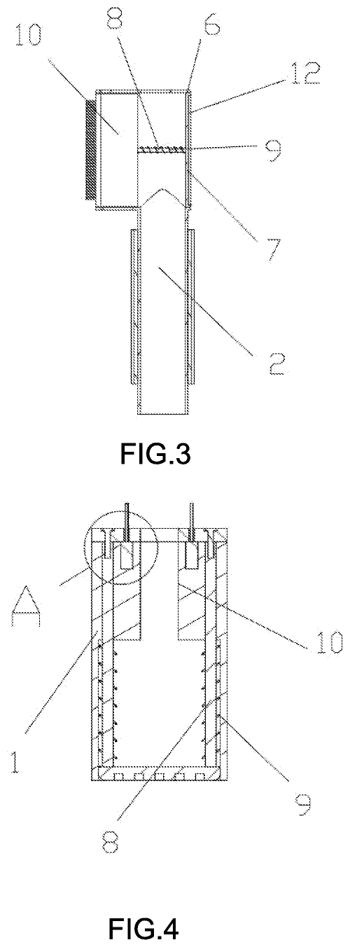

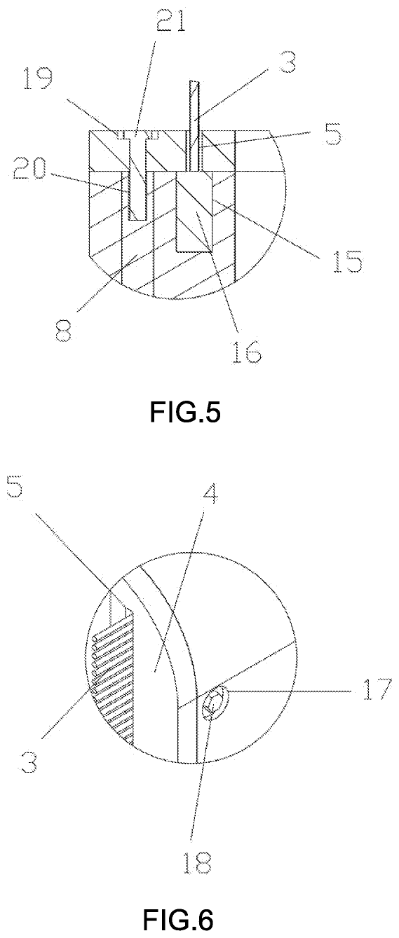

Please refer to FIGS. 2-6, the present invention provides a technical solution by a pet hair trim clipper comprising a main clipper body 1, and a handle 2 fixedly connected to a bottom of the main clipper body 1. Two sets of trimmer members 3 are arranged on a front of the main clipper body 1, a hair removing element 4 which can be a plate is arranged on the front of the main clipper body 1, two sets of slots 5 are formed at the front side of the hair removing element 4 for the trimmer members 3 to pass through the inner cavity of the slots 5, a button slot 6 is formed on a back of the main clipper body 1, a pressing button 7 is arranged in the inner cavity of the button slot 6, a connecting rod 8 is arranged in the inner cavity of the main clipper body 1, a reset spring 9 is arranged on the outer circumference of the connecting rod 8, an air duct slot 10 is form at the front side of the main clipper body 1, a second slot 11 is opened at the front side of the hair removing element 4, and an anti-slip pattern 12 is arranged on a back of the pressing button 7.

The handle 2 is a hollow tube, and the inner cavity of the handle 2 is in communication with the main clipper body 1.

The second slot 11 is in communication with the air duct slot 10, and the air duct slot 10 is in communication with the inner cavity of the main clipper body 1.

The connecting rod 8 penetrates through the inner cavity of the main clipper body 1 and is connected to the hair removing element 4. A back of the connecting rod 8 is connected to the pressing button 7.

In this embodiment, the hair after trimming will hang on the trimmer members 3, a suction pipe of a vacuum device can be connected to the handle 2, and the pressing button 7 is pressed to move the hair removing element 4 forward through the connecting rod 8, so that the pet hair on the trimmer members 3 passing through the slot 5 is removed, and the pet hair is sucked into the vacuum device from the second slot 11 through the air duct slot 10 and finally into the handle 2, thereby achieving the purpose of quickly removing and collecting the pet hair.

The outer side of the handle 2 is provided with a sleeve 13, and the sleeve 13 is provided with a second anti-slip pattern 14.

In this embodiment, when trimming the pet hair, the sheath 13 of the handle 2 is held by the user, and the friction between the hand and the handle 2 is increased by the introduction of the second anti-slip pattern 14, so as to ensure the smooth trimming operation of the pet hair.

The front side of the main clipper body 1 is provided with an installation groove 15, and the inner cavity of the installation groove 15 is provided with an installation block 16 which is connected to the trimmer members 3.

There are fixing holes 17 in both side portions of the main clipper body 1, and the inner cavity of the fixing holes 17 are respectively provided with fixing bolts 18 which pass through the inner cavity of the installation groove 15 penetrating through the mounting block 16.

The front of the hair removing element 4 is provided with a second fixing hole 19, and the inner cavity of the fixing hole 19 is provided with a connecting bolt 21. The front of the connecting rod 8 is provided with a connecting screw hole 20, and the connecting bolt 21 penetrates through the inner cavity of the second fixing hole 19 to reach the inner cavity of the connecting screw hole 20.

In this embodiment, when the main clipper body 1 has been used for a long time and the trimmer members 3 are damaged, the connecting bolt 21 in the second fixing hole 19 can be unscrewed from the connecting screw hole 20, and then the hair removing element 4 can be separated from the connecting rod 8, so that the hair removing element 4 can be removed. After that, the fixing bolt 18 in the fixing hole 17 can be removed, and then the mounting block 16 can be taken out of the mounting groove 15, so that the trimmer members 3 can be disassembled, and the purpose of convenient replacement of the trimmer members 3 is achieved; after the hair removing element 4 is disassembled from the front of the main clipper body 1, the pressing button 7 in the pressing groove 6 can be taken out, so that the internal of the main clipper body 1 can be cleaned to avoid the accumulation of dust and other debris affecting the subsequent thinning work, and improve the convenience of internal cleaning of the pet hair trim clipper of this embodiment.

The working principle is illustrated in the following description. When it is necessary to use the pet hair trim clipper to trim the hair on the pet's body, the user can hold on the sheath 13 on the handle 2, the friction between the hand of the user and the handle 2 is increased because of the second anti-slip pattern 14, so as to ensure smooth trimming operation of the hair. Then, the two rows of trimmer members 3 on the main clipper body 1 are used to trim the hair on the pet's body. The two rows of trimmer members 3 greatly improve the efficiency of trimming and grooming the pet's hair, avoiding the pet losing patience due to long trimming time and causing harm to humans, so as to indirectly improve the safety of thinning the pet's hair. After the pet's hair is trimmed and groomed, the hair will be hanging on the trimmer members 3. At this time, a suction pipe of a vacuum device can be connected to the hollow tubular shaped handle 2. When the pressing button 7 with the anti-slip pattern 12 is pressed, the hair removing element 4 is driven to move forward by the connecting rod 8 to remove the pet's hair on the trimmer members 3 which pass through the grooves 5. At the same time, the vacuum device is activated, and the pet's hair enters the air duct groove 10 from the second groove 11, and then the hair is sucked into the main clipper body 1, and finally sucked into the vacuum device from the handle 2, achieving the purpose of quickly removing and collecting the pet's hair, and solving the problem that it is difficult to handle the hair quickly by the conventional pet hair trim comb. After releasing the pressing button 7, under the action of the reset spring 9, the hair removing element 4 returns to its original position, and the next trimming operation can be carried out. When the main clipper body 1 has been used for a long time and the trimmer members 3 may be damaged, the connecting bolt 21 in the second fixing hole 19 can be unscrewed from the connecting screw hole 20, and then the hair removing element 4 can be separated from the connecting rod 8, and then the hair removing element 4 can be removed. The fixing bolt 18 in the fixing hole 17 can be removed, and then the installation block 16 can be taken out of the installation groove 15, so that the trimmer members 3 can be disassembled, achieving the purpose of convenient replacement of the trimmer members 3. After removing the hair removing element 4 from the front of the main clipper body 1. the pressing button 7 in the button groove 6 can be taken out, and then the internal of the main clipper body 1 can be cleaned to avoid the accumulation of dust and other debris affecting the later thinning work, improving the convenience of internal cleaning of the pet hair trim clipper.

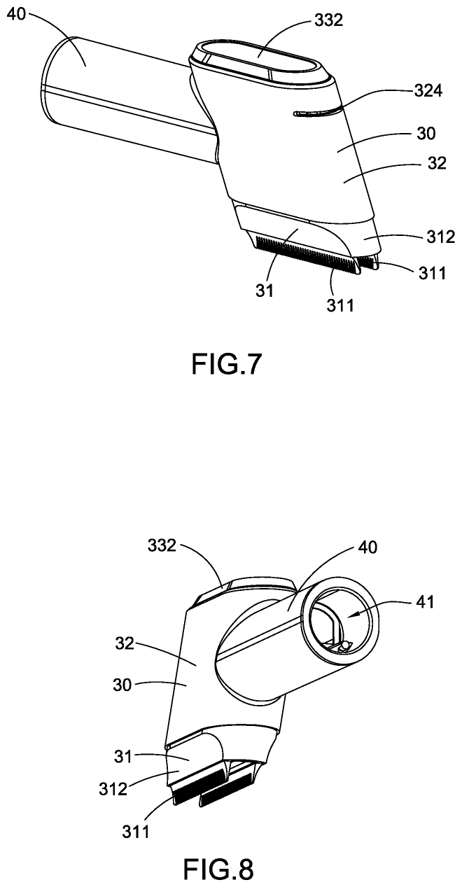

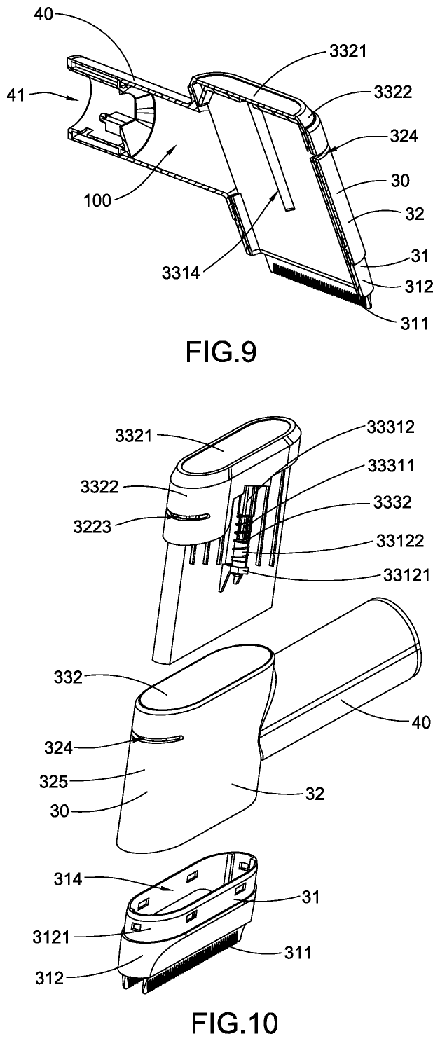

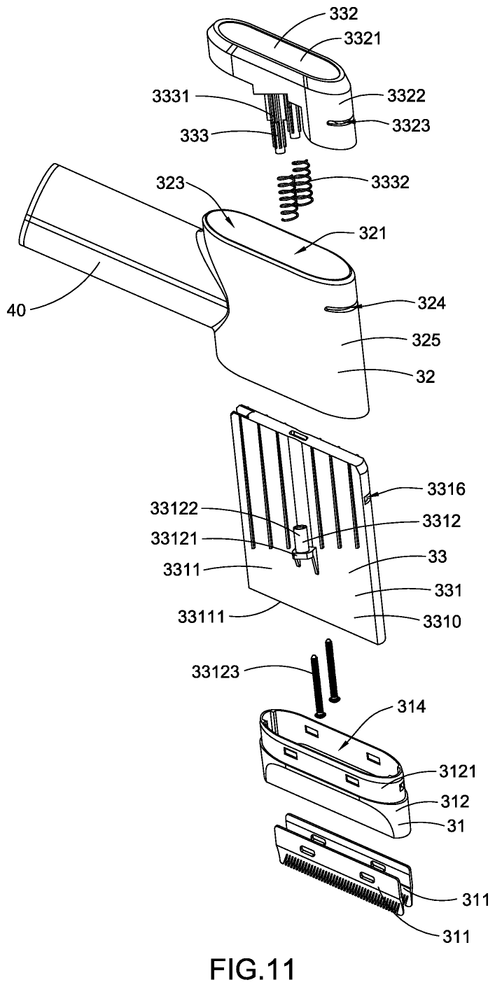

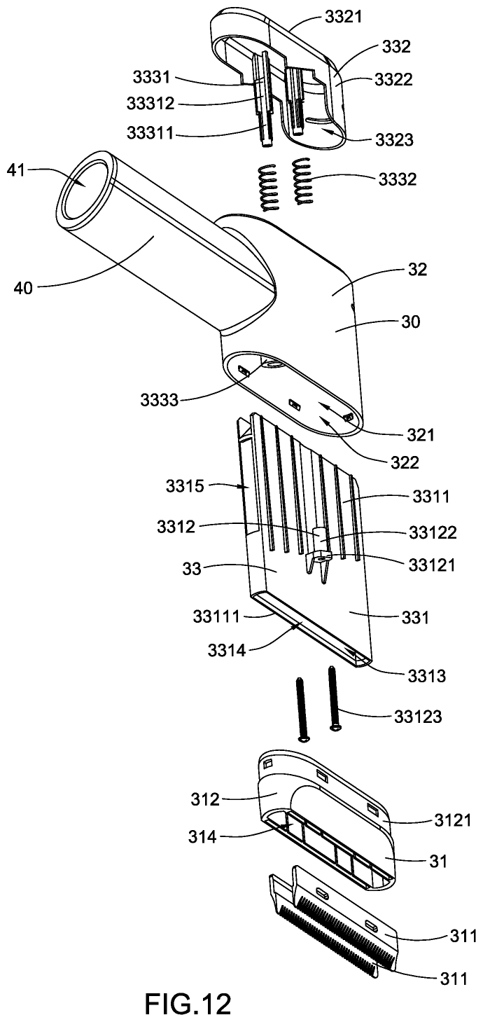

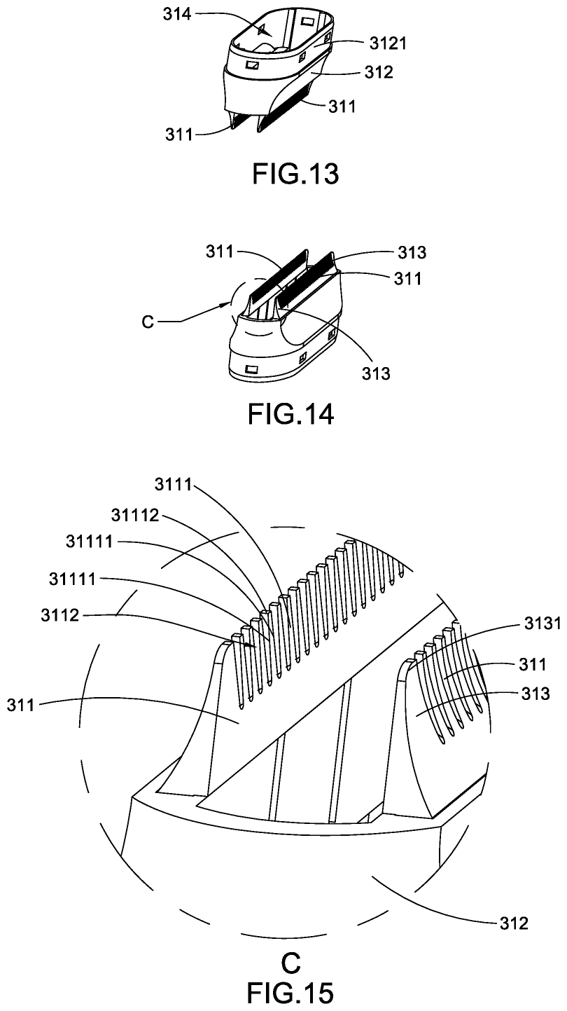

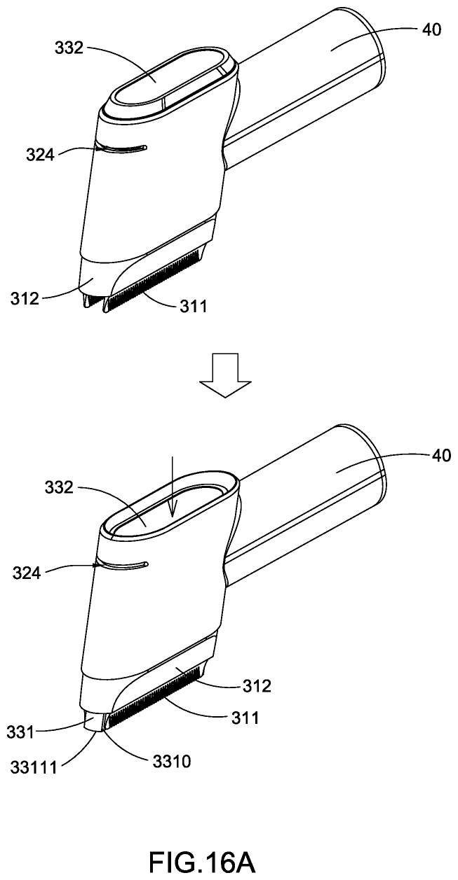

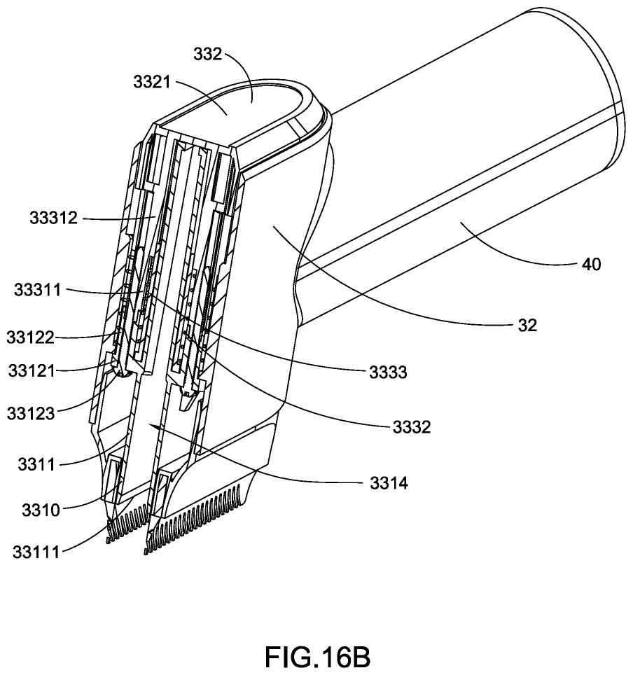

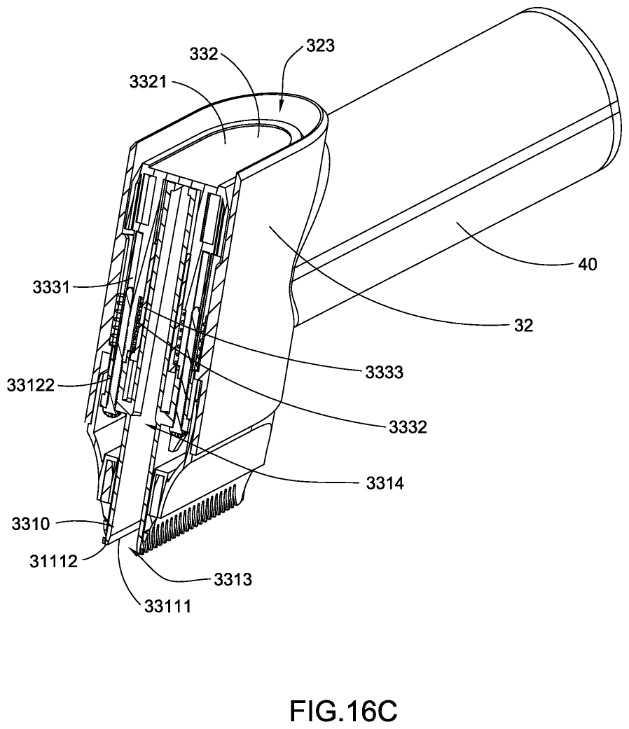

Referring to FIG. 7 to FIG. 18 of the drawings, a pet hair trim clipper according to a second preferred embodiment of the present invention is illustrated. The pet hair trim clipper comprises a main clipper body 30 for trimming and grooming the hair of the pet and a handle 40 connected to the main clipper body 30 for the user to hold on.

The main clipper body 30 comprises a trim assembly 31 and a clipper housing 32, wherein the trim assembly 31 is mounted to the clipper housing 32 for trimming, grooming and cutting the hair of the pet. According to this preferred embodiment, the trim assembly 31 comprises at least one longitudinal trim cutter 311 for carrying out the trimming operation of the hair of the pet. The handle 40 is connected to the clipper housing 32. Accordingly, the handle 40 is integrally extended from the clipper housing 32, or the handle 40 is assembly with the clipper housing 32.

According to the present invention, the longitudinal trim cutter 311 is not extended in a transverse direction like the conventional pet hair trim comb, but is extended along a same direction of a longitudinal direction D1 of the handle 40, which is also the longitudinal direction of the pet hair trim clipper along a length of the pet hair trim clipper.

Accordingly, the longitudinal trim cutter 311 comprises a row of trimmer members 3111 which is actually extended in a longitudinal direction of the handle 40, so that when the pet is standing, sitting or lying in front of the user, the user can hold on the handle 40 so as to trim and groom the hair of the pet in a trimming direction D2 that is perpendicular to the longitudinal direction of the handle 40, so that the wrist of the user is in a natural state, so that it is easy and convenient for the user to carry out the pet hair trimming operations, and the hand of the user will not feel tired.

Furthermore, the trim assembly 31 of the main clipper body 30 of the present invention comprises two longitudinal trim cutters 311 which are spaced apart from each other. Both of the two longitudinal trim cutters 311 are extended along the D1 direction, and each of the two longitudinal trim cutters 311 comprises a row of the trimmer members 3111, a gap 3112 is formed between two adjacent trimmer members 3111 of the row of the trimmer members 3111. Accordingly, each of the two longitudinal trim cutters 311 has a plurality of gaps 3112 which serve as the pathways to allow the hair of the pet to enter, so that when the hair of the pet get drawn into the gaps by the movement of the longitudinal trim cutters 311, the hair of the pet can be in contact with the trimmer members 3111 and be cut cleanly and evenly by the action of the trimmer members 3111.

Each of the trimmer members 3111 is a blade element which has two sharp cutting edges 31111 at two sides thereof, when the hair of the pet enters the gaps 3112, the hair will be caught between the cutting edges 31111, so that the hair is cut efficiently as the user repeatedly move the pet air trim clipper across the body of the pet along the trimming direction of D2 which is the direction of the hair growth.

In the present invention, the hair trimming direction D2 of the longitudinal trim cutters 311 is perpendicular to a longitudinal extending direction of the handle 40 which is along the direction of D1, so that the user can naturally hold on the handle 40 for the hair trimming operations on the pet which is in front of the user.

In addition, in this embodiment, the two longitudinal trim cutters 311 are arranged in opposite configurations. Particularly, the grim assembly 31 comprises a trim base 312, each of the two longitudinal trim cutters 311 can be inclinedly or curvedly extended from the trim base 312. However, the two longitudinal trim cutters 311 are not extended from the trim base 312 with a same configuration, but in a back-to-back manner.

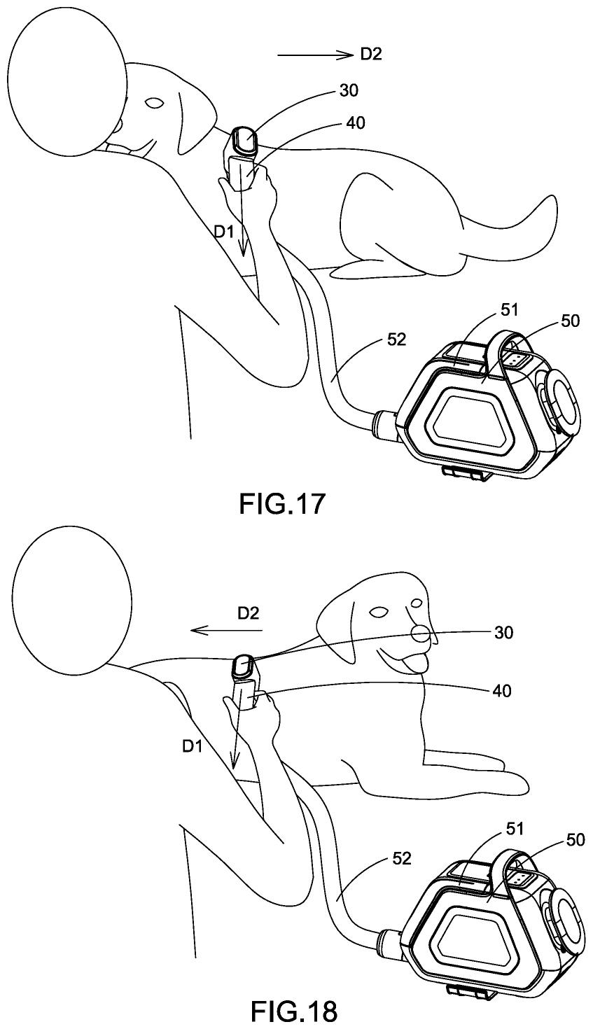

With reference to FIG. 17 and FIG. 18 of the drawings, in this embodiment, the two longitudinal trim cutters 311 are curvedly and inwardly extended toward each other, so that the two longitudinal trim cutters 311 allow the user to trim and groom the pet hair in two opposite hair trimming directions D2, so that when the pet is standing, sitting or lying in front of the user, regardless of the extending direction of the body of the pet, the user is always able to trim the pet hair with the pet hair trim clipper of the present invention without changing the holding hand for holding the handle 40 while ensuring that the hair trimming direction D2 is the direction of hair growth of the pet.

More specifically, as shown in FIG. 17 of the drawings, when the pet is in front of the user with its head on the left side, the user is able to hold on the handle 40 to trim the pet hair along a rightward hair trimming direction D2, the left longitudinal trim cutter of the two longitudinal trim cutters 311 will be the main cutter for cutting the pet hair.

As shown in FIG. 18 of the drawings, when the pet is in front of the user with its head on the right side, the user is able to hold on the handle 40 to trim the pet hair along a leftward hair trimming direction D2, the right longitudinal trim cutter of the two longitudinal trim cutters 311 will be the main cutter for cutting the pet hair.

In addition, no matter the occasion that the pet in front of the user with its head on the left side or the right side, a random hand of the two hands of the user can be used the holding hand to hold and move the pet hair trim clipper. Therefore, the pet hair trim clipper of the present invention can be especially handy for those who are less experienced with grooming, as it simplify the process by allowing for more natural and intuitive operations, so that the pet owner can do the pet hair cutting at home by himself or herself, rather than to take the pet to a pet clinic.

The person of ordinary skilled in the art should understand that during the hair trimming operations of the pet hair trim clipper of the present invention, the two longitudinal trim cutters 311 may have contact with the pet hair. Alternatively, only the main cutter of the two longitudinal trim cutters 311 is having contact with the pet hair trim clipper is used for pet hair cutting.

The trim base 312 can be detachably mounted to the clipper housing 32, so that the trim assembly 31 can be detachably mounted to the clipper housing 32, and thus when one or more of the longitudinal trim cutters 311 are damaged, the user can detach the trim assembly 31 from the clipper housing 32 and replace a new trim assembly 31.

In addition, the pet hair trim clipper may be provided with a set of trim assemblies 31 which have different sizes and configurations of the longitudinal trim cutters 311, so that the user is able to select a desired trim assembly 31 and assemble the desired trim assembly 31 on the clipper housing 32.

For example, the trim assemblies 31 having different lengths of the gaps 3112 of the longitudinal trim cutters 311, so that the cutting length of the pet hair is different, so that the user can select a trim assemblies 31 with a desired cutting length for his or her pet.

As shown in FIG. 10 of the drawings, the trim base 312 of the trim assembly 31 may comprise an inserting portion 3121 which can be inserted into the clipper housing 32, so as to detachably mount the trim assembly 31 to the clipper housing 32. Screws, rivets or bolts may be further used for mounting the trim base 312 to the clipper housing 32.

In addition, as shown in FIG. 15 of the drawings, each of the longitudinal trim cutters 311 of the trim assembly 31 comprises two side edges 313 each comprises an arc end edge portion 3131 at a distal end thereof, so that no sharp edges are formed on the side edges 313, so that when the longitudinal trim cutters 311 are used for hair cutting, the arc end edge portions 3131 prevent the longitudinal trim cutters 311 to hurt the pet hair on the pet.

The main clipper body 30 further comprises a hair removing assembly 33 for removing the hair on the longitudinal trim cutters 311 of the trim assembly 31 when the air has been cut down from the pet. More specifically, the hair removing assembly 33 comprises a hair removing element 331, an actuator 332, a driving element 333 connected to the actuator 332 for driving the hair removing element 331 to scrape the hair on the longitudinal trim cutters 311 of the trim assembly 31.

The hair removing element 331 can be embodied to have a structure like the hair removing element 4 of the above first preferred embodiment that is a plate that allows the rows of the trim members 3 to pass through. In this embodiment, the hair removing element 331 comprises a moving sleeve 3311 which comprises a pusher edge 33111, each of the trimmer members 3111 of the longitudinal trim cutters 311 has an end edge 31112 extended between the two cutting edges 31111, the pusher edge 33111 of the moving sleeve 3311 can be driven to be moved to a position corresponding to the end edges 31112 of the longitudinal trim cutters 311, or may be driven to a position beyond the end edges 31112 of the longitudinal trim cutters 311, so as to scrape down the hair on the longitudinal trim cutters 311.

In this embodiment, the pusher edge 33111 of the hair removing element 331 is a circular edge, and the trimmer members 3111 of the longitudinal trim cutters 311 are provided around the pusher edge 33111, so that the circular pusher edge 33111 is able to be driven to move to scrape down the hair on both of the two longitudinal trim cutters 311.

As shown in FIGS. 10 to 12 of the drawings, the trim assembly 31 has a central slot 314 formed in the trim base 312, the two longitudinal trim cutters 311 are provided at two opposite sides of the central slot 314. The central slot 314 is elongated in shape and extended in the longitudinal direction D1 of the handle 40 of the pet hair trim clipper, the two longitudinal trim cutters 311 are also elongated in shape and spacedly arranged at the trim base 312.

The hair removing element 331 comprises an pusher end portion 3310 which is inserted into the central slot 314, the pusher edge 31112 is formed on the pusher end portion 3310, when the actuator 332 is operated, the driving element 333 connected to the actuator 332 is driven to drive the hair removing element 331 to move, so that the pusher end portion 3310 is driven to to be sliding and moving between the two longitudinal trim cutters 311 until the pusher edge 33111 is moved to the end edges 31112 of the longitudinal trim cutters 311, so as to scrape the hair on the longitudinal trim cutters 311 of the trim assembly 31.

The clipper housing 32 has a clipper chamber 321 for receiving the hair removing element 331 and the driving element 333, a bottom opening 322 communicated to the clipper chamber 321 for mounting the trim base 312 of the trim assembly 31, and a top groove 323 for mounting the actuator 332. Accordingly, when the actuator 332, which can be embodied as a pressing button, is pressed by the user to slide in the top groove 323, the driving element 333 is actuated to move to drive the hair removing element 331 to slide between the two longitudinal trim cutters 311.

According to this embodiment, the driving element 333 comprises at least a connecting member 3331 and at least a reset member 3332 coupled to the corresponding connecting member 3331 for resetting the driving element 333 and the actuator 332 when the actuator 332 is released.

The hair removing element 331 further comprises at least a mounting member 3312 transversely extended from the moving sleeve 3311 for mounting with he connecting member 3331 of the driving element 333.

More specifically, the driving element 333 comprises two connecting members 3331 and two reset members 332, and the hair removing element 331 comprises two mounting members 3312. Each of the two connecting members 3331 may be embodied as a connecting rod that is connected between the actuator 332 and the corresponding mounting member 3312 which is connected to an outer surface of the moving sleeve 3311. Each of the two reset members 332 is illustrated to be a reset compression spring in this embodiment. Alternatively, each of the two reset members 332 can be embodied to other reset structure such as a torsion spring.

Referring to FIGS. 10 to 12 and FIGS. 16A and 16B of the drawings, each of the mounting members 3312 comprises a mounting plate 33121 and a mounting tube 33122 extended from the mounting plate 33121 for receiving an end portion of the corresponding connecting member 3331. Each of the connecting members 3331 comprises a lower connecting portion 33311 and an upper connecting portion 33312 which is integrally extended form the lower connecting portion 33311. The lower connecting portion 33311 of each connecting member 3331 is connected to the mounting tube 33122 of the corresponding mounting member 3312, the upper connecting portion 33312 of each connecting member 3331 is connected to a bottom of the actuator 332. In addition, a connector 33123, which can be a rivet, a screw or a bolt, can be used to connect each mounting plate 33121 to the corresponding connecting member 3331.

In this embodiment, the lower connecting portion 33311 of each connecting member 3331 comprises an lower end that is inserted into the corresponding mounting tube 33122, and the lower connecting portion 33311 has a diameter that is smaller that a diameter of the upper connecting portion 33312, and the corresponding reset member 3332 which is embodied as a compression spring is wound around the lower connecting portion 33311 of each connecting member 3331 and is retained in a position between the mounting plate 33121 of the corresponding mounting member 3312 and the upper connecting portion 33312 of each connecting member 3331.

When in an actuated state that the actuator 332 is pressed, the actuator 332 drives the corresponding connecting members 3331 to move downward, each upper connecting portion 33312 will apply a pushing force to the corresponding reset member 3332 to compress the compression spring. And when the actuator 332 is released, the restoring of the reset members 3332 will reset the position of the actuator 332 and the connecting members 3331.

In addition, the driving element 333 further comprises two guiding members 3333 which are embodied as two guiding tubes which are mounted to the clipper housing 32 and extended into the clipper chamber 321 for guiding and restricting the sliding movement of the two connecting members 3331. Accordingly, the lower connecting portion 33311 of each connecting member 3331 is sliding in the corresponding guiding members 3333 when the actuator 332 is pressed, and the engagement between the mounting members 3312, the guiding members 3333, the connecting members 3331, the rest members 3332, and the actuator 332 can be configured to set the stop positions of the connecting members 3331, as long as the pusher edge 33111 of the hair removing element 331 can be moved to a position corresponding to the end edges 31112 of the trim members 3111 of the two longitudinal trim cutters 311, or be moved to a position beyond the end edges 31112 of the trim members 3111 of the two longitudinal trim cutters 311.

In this embodiment, the two rest members 3332 are respectively assembled in the two guiding members 3333. When in an idle state that the actuator 332 is not pressed, each reset member 3332 is in a natural stretched state and two ends of each reset member 3332 are respectively biasing against a top inner surface of the corresponding guiding member and a bottom end surface of the upper connecting portion 33312.

Alternatively, the relative movement between the hair removing element 331 and the two longitudinal trim cutters 311 can be achieved by fixing the hair removing element 331 and pulling the actuator 333 to direct the trim base 312 to move, so as to move the end edges 31112 of the two longitudinal trim cutters 311 towards the pusher edge 33111 of the hair removing element 331.

As shown in FIGS. 17 and 18 of the drawings, the pet hair trim clipper may further comprise a vacuum machine 50 which comprises a machine body 51 and a connecting pipe 52 that can be detachably mounted to the handle 40 which has a hollow structure, so that the vacuum machine 50 can be used to draw the cut hair on the longitudinal trim cutters 311 into the vacuum machine 50, so as to remove the cut hair on the longitudinal trim cutters 311, so that the longitudinal trim cutters 311 can be kept in a clean state. The main body 51 may comprises components such as vacuum creating arrangement, air filters, and hair storing chamber. The vacuum creating arrangement may comprise one or more motors and one or more wind impellers.

More specifically, the moving sleeve 3311 of the hair removing element 331 has a bottom suction opening 3313 which is communicated to a sleeve chamber 3314 of the moving sleeve 3311 of the hair removing element 331. The handle 40 has a handle chamber 41, the moving sleeve 3311 of the hair removing element 331 further has a communicating hole 3315 communicating the sleeve chamber 3314 to the handle chamber 41 of the handle 42, so that the sleeve chamber 3315 of the hair removing element 331 and the handle chamber 41 of the handle 40 actually form an air duct 100.

Accordingly, when the connecting pipe 52 of the vacuum machine 50 is connected to the handle 40, the air duct 100 is communicated to a channel in the connecting pipe 52, so that when the machine body 51 is actuated to operate, the hair on the two longitudinal trim cutters 311 are drawn into the air duct 100 through the suction opening 3313 of the moving sleeve 3311 of the hair removing element 331, and finally sucked into the machine body 51 through the air duct 100 and the channel in the connecting pipe 52, so that the cut hair can be collected in the machine body 51 of the vacuum machine 50.

During the pet hair trimming operation, the machine body 51 of the vacuum machine 50 can be away from the pet with a predetermined distance, so that the pet can feel comfortable and will not get annoyed by the noise of the working machine body.

It is worth mentioning that the machine body 51 of the vacuum machine 50 can be activated after several trimming operations by the longitudinal trim cutters 311, or the machine body 51 of the vacuum machine 50 is kept in working during the trimming operations by the longitudinal trim cutters 311.

In other words, the user can hold on the handle 40 of the pet hair trim clipper of the present invention to trim and groom the hair of the pet, and cut hair will be hung on the longitudinal trim cutters 311, and when there is a significant amount of cut hair is accumulated on the longitudinal trim cutters 311, the user can disengage the pet hair trim clipper with the coat of the pet, and then mount the connecting pipe 52 of the vacuum machine 50 to the handle 40, and then turn on the machine body 51 of the vacuum machine 50, and can press the actuator 332 for driving the hair removing element 331 to scrape down the cut hair on the longitudinal trim cutters 311, so that the cut hair is drawn into the machine body 51 of the vacuum machine 50 through the air duct 100. Accordingly, in this example, when the machine body 51 is working for sucking the cut hair, the main clipper body 30 is away from the pet, so that the pet will feel comfortable.

Alternatively, after the connecting pipe 52 of the vacuum machine 50 is connected to the handle 40, the user also may turn on the machine body 51 of the vacuum machine 50, and then hold on the handle 40 of the pet hair trim clipper to trim and groom the hair of the pet. At this time, the hair cut down from the pet by the longitudinal trim cutters 311 are simultaneously sucked into the machine body 51 of the vacuum machine 50, and the user, from time to time, may press the actuator 332 for scraping the hair on the longitudinal trim cutters 311 by the hair removing element 331.

In this embodiment, the clipper housing 32 further has a vacuum adjusting hole 324. When the machine body 51 of the vacuum machine 50 is in operation to create a vacuum in the air duct 100 for drawing the cut hair, there is a possibility that a few cut hair on the longitudinal trim cutters 311 may remain its position, or may attach on the inner surface of the moving sleeve 3311, the inner surface of the handle 40, and the inner surface of the clipper housing 32, and the vacuum adjusting hole 324 can be gradually closed or gradually opened by the finger of user, so as to adjust the air pressure and vacuum level in the air duct 100, so that the few cut hair remained on the longitudinal trim cutters 311, the inner surface of the moving sleeve 3311, the inner surface of the handle 40, or the inner surface of the clipper housing 32 can be driven to move, and then is successfully drawn into the connecting pipe 52 of the vacuum machine 50.

In this embodiment, the moving sleeve 3311 of the hair removing element 331 further has a vent hole 3316. The actuator 332 comprises a pressing portion 3321 for being pressed by the user and a cover portion 3322 connected to the pressing portion 3321 which is shaped and sized to match a front portion 325 of the clipper housing 32 which has the vacuum adjusting hole 324. The cover portion 3322 has a connecting hole 3323 which is aligned with the vent hole 3316 of the hair removing element 331, and is shaped and sized to match with the vacuum adjusting hole 324 of the clipper housing 32.

When in the idle state that the actuator 332 is not pressed, the vent hole 3316 of the hair removing element 331 is aligned with the connecting hole 3323 of the cover portion 3322, and the vacuum adjusting hole 324 of the clipper housing 32.

When the pressing portion 3321 of the actuator 332 is pressed to its lowest position for driving the hair removing element 331 to scrape down the cut hair on the longitudinal trim cutters 311, the cover portion 3322 of the actuator 332 is driven to move, so that the connecting hole 3323 of the cover portion 3322 is not aligned with the vacuum adjusting hole 324 of the clipper housing 32, and thus the vacuum adjusting hole 324 of the clipper housing 32 is blocked by the cover portion, and the vacuum adjusting hole 324 of the clipper housing 32 is prevented from communicating with the clipper chamber 321 of the clipper housing 32 and the sleeve chamber 3314 of the moving sleeve 3311 of the hair removing element 331, so as to ensure that the vacuum in the air duct 100 can be created when the machine body 51 of the vacuum machine 50 is in operation. Therefore, when the hair removing element 331 is moved to its lowest position for directing the pusher edge 33111 to scrape down the cut hair on the longitudinal trim cutters 311, the vacuum level in the air duct 100 is the largest, so as to draw the cut hair into the air duct 100 as much as possible.

When the pressing portion 3321 of the actuator 332 is released, the cover portion 3322 of the actuator 332 is driven to move back, the connecting hole 3323 of the cover portion 3322 and the vent hole 3316 of the hair removing element 331 are gradually moved to be align with the vacuum adjusting hole 324 of the clipper housing 32, and thus the vacuum adjusting hole 324 of the clipper housing 32 can be communicated with the clipper chamber 321 of the clipper housing 32 and the sleeve chamber 3314 of the moving sleeve 3311 of the hair removing element 331, so that the vacuum level and air pressure in the air duct 100 can be adjusted when the machine body 51 of the vacuum machine 50 is in operation. The repeat pressing operation on the actuator 332 can result in the corresponding times of vacuum change in the air duct 100, so as to result in the motion of the few cut hair remained on the longitudinal trim cutters 311, the inner surface of the moving sleeve 3311, the inner surface of the handle 40, or the inner surface of the clipper housing 32, so that these cut hair can be drawn into the connecting pipe 52 of the vacuum machine 50, and finally reach to the machine body 51 of the vacuum machine 50.

It is worth mentioning that in other possible alternative modes, the person of ordinary skilled in the art should understand that the cover portion 3322 also can be connected to or integrally formed on the hair removing element 331. The vacuum adjusting hole 324 may be formed in the handle 40.

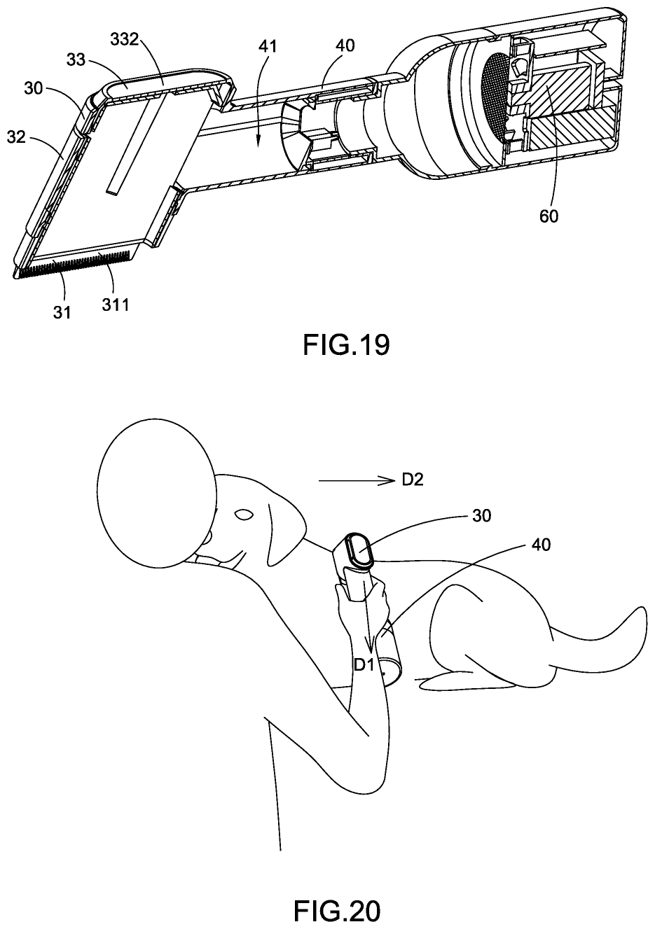

Referring to FIG. 19 and FIG. 20 of the drawings, a pet hair trim clipper according to a first alternative mode of the above second preferred embodiment of the present invention is illustrated. In this embodiment, the pet hair trim clipper comprises a main clipper body 30 comprising the longitudinal trim cutters 311 for trimming and grooming the hair of the pet, a handle 40 connected to the main clipper body 30 for the user to hold on, and a wind suction assembly 60 mounted in the handle 40, so that as shown in FIG. 20 of the drawings, the user can hold on the handle 40 and activate the wind suction assembly 60 in the handle 40 to trim the pet hair. The suction assembly 60 may comprise components such as a motor, a wind impeller, and a hair storing chamber.

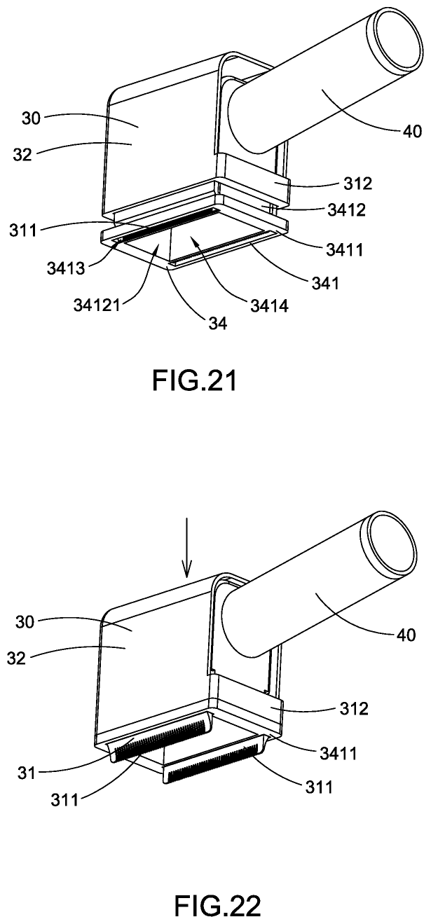

Referring to FIGS. 21 and 22 of the drawings, a pet hair trim clipper according to a second alternative mode of the above second preferred embodiment of the present invention is illustrated. In this embodiment, the pet hair trim clipper comprises a main clipper body 30 for trimming and grooming the hair of the pet, a handle 40 connected to the main clipper body 30 for the user to hold on.

The main clipper body 30 comprises a trim assembly 31, a clipper housing 32 and a hair removing assembly 34. The trim assembly 31 comprises two longitudinal trim cutters 311 and a trim base 312 for mounting and supporting the two longitudinal trim cutters 311. In addition, in this embodiment, the trim base 312 is connected to the clipper housing 32.

The hair removing assembly 34 of this embodiment comprises a hair removing element 341 which comprises a hair removing plate 3411 and a supporting sleeve 3412 connected to the supporting sleeve 3412. The hair removing plate 3411 has two slots 3413 and a second slot which is a suction opening 3414 which is communicated to a sleeve chamber 34121 of the supporting sleeve 3412. And the sleeve chamber 34121 of the supporting sleeve 3412 is communicated to the handle housing of the handle 40.

According to this embodiment, the clipper housing 32 is slidably coupled to the supporting sleeve 3412 in a manner that when a top of the clipper housing 32 is pressed, the clipper housing 32 can be driven to slide along an outer side of the supporting sleeve 3412, so that the trim base 312 connected to the clipper housing 32 is driven to move, so as to direct the two longitudinal trim cutters 311 to pass through the two slots 3413 in the hair removing plate 3411 respectively for pet hair trimming and grooming. The person of ordinary skilled in the art should understand that one or more reset members can be also provided in the clipper housing 32 so restore the initial position of the clipper housing 32.

When a vacuum machine 50 is connected to the handle 40, and by pressing the top of the clipper housing 32, the cut hair on the longitudinal trim cutters 311 can be sucked into the supporting sleeve 3412 through the suction opening 3414, and then be further drawn into the machine body 51 of the vacuum machine 50 through the handle chamber of the handle 41 and the channel of the connecting pipe 52.

According to this embodiment, the hair removing plate 3411 of the hair removing element 341 is fixed, while the two longitudinal trim cutters 311 can be driven to move, so as to adjust the relative position between the hair removing plate 3411 of the hair removing element 341 and the two longitudinal trim cutters 311, so as to allow the hair removing plate 3411 of the hair removing element 341 to scrape down the cut hair on the two longitudinal trim cutters 311.

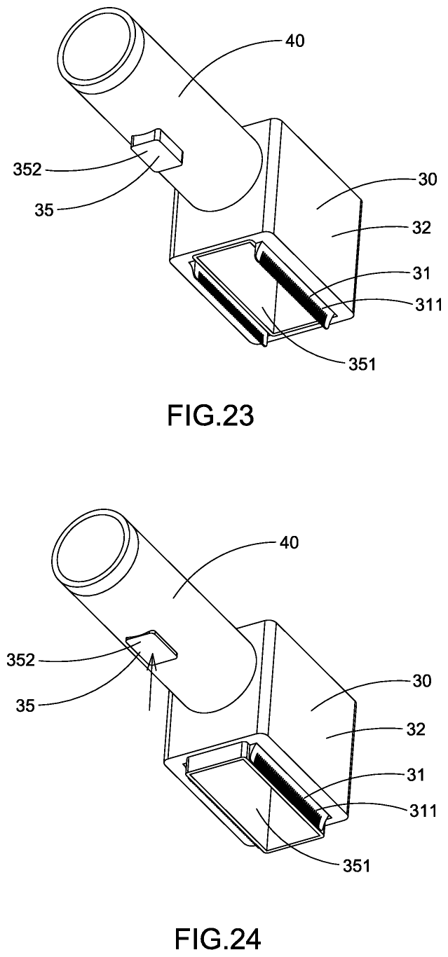

Referring to FIGS. 23 and 24 of the drawings, a pet hair trim clipper according to a third alternative mode of the above second preferred embodiment of the present invention is illustrated. In this embodiment, the pet hair trim clipper comprises a main clipper body 30 for trimming and grooming the hair of the pet, a handle 40 connected to the main clipper body 30 for the user to hold on.

The main clipper body 30 comprises a trim assembly 31, a clipper housing 32 and a hair removing assembly 35. The trim assembly 31 comprises two longitudinal trim cutters 311 and a trim base 312 for mounting and supporting the two longitudinal trim cutters 311. In addition, in this embodiment, the trim base 312 is connected to the clipper housing 32.

The hair removing assembly 35 comprises a hair removing element 351, an actuator 352 and a driving element The hair removing element 351 has a similar structure as the hair removing element 331 of the above preferred embodiment, the actuator 352 of this embodiment is mounted to the handle 40, rather than the clipper housing 32. The driving element can be a lever member which is provided with a reset member, so that when the actuator 352 is pressed, the lever member of the driving element can be driven to pivotally move, so as to drive the hair removing element 351 to move with respect to the two longitudinal trim cutters 311 for scraping down the cut hair on the fixed two longitudinal trim cutters 311.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A pet hair trim clipper, comprising:
a main clipper body; and
a handle connected to said main clipper body, wherein said main clipper body comprises at least one longitudinal trim cutter for trimming the pet hair.

2. The pet hair trim clipper according to claim 1, wherein a trimming direction of said at least one longitudinal trim cutter is perpendicular to a longitudinal direction of said handle.

3. The pet hair trim clipper according to claim 1, wherein said main clipper body comprises a trim assembly and a hair removing assembly, wherein said trim assembly comprises two longitudinal trim cutters, wherein said hair removing assembly and said trim assembly are configured to allow a relative movement therebetween, so as to allow said hair removing assembly to scrape down the pet hair on said two longitudinal trim cutters.

4. The pet hair trim clipper according to claim 3, wherein said hair removing assembly comprises a hair removing element, an actuator, and a driving element, wherein said driving element comprises a connecting member connected to said actuator, and a reset member, wherein when said actuator is operated, said connecting member is driven to move, so as to drive said hair removing element to move with respect to said two longitudinal trim cutters, wherein when said actuator is released, said reset member reset said actuator, said connecting member and said hair removing element.

5. The pet hair trim clipper according to claim 4, wherein said hair removing element comprises a moving sleeve which comprises a pusher end portion, wherein said trim assembly has a central slot for allowing said pusher end portion to penetrate therethrough to slide between said two longitudinal trim cutters for scraping down the pet hair on said two longitudinal trim cutters.

6. The pet hair trim clipper according to claim 5, wherein said moving sleeve has a sleeve chamber and a suction opening communicated to said sleeve chamber, wherein said handle has a handle chamber which is communicated to said sleeve chamber of said moving sleeve to form an air duct.

7. The pet hair trim clipper according to claim 6, wherein said pusher end portion of said hair removing element comprises a pusher edge which is circular in shape, wherein each of said two longitudinal trim cutters comprises a plurality of trim members and having a plurality of gaps between two adjacent trim members, wherein each of said trim members comprises two cutting edges and an end edge extended between said two cutting edges, wherein said hair removing element is configured to be moved to allow said pusher edge to be moved to a position corresponding to said end edges of said trim members of said two longitudinal trim cutters to scrape down the pet hair on said two longitudinal trim cutters.

8. The pet hair trim clipper according to claim 7, wherein each of said two longitudinal trim cutters comprises two side edges, wherein said trim members are arranged between said two side edges, wherein each of said two side edges comprises an arc end edge portion.

9. The pet hair trim clipper according to claim 5, wherein said hair removing element further comprises a mounting member connected to said moving sleeve, wherein said mounting members comprises a mounting plate and a mounting tube extended from said mounting plate for mounting said connecting member, wherein said connecting members comprises a lower connecting portion and an upper connecting portion which is integrally extended form said lower connecting portion, wherein said lower connecting portion of said connecting member is connected to said mounting tube, said upper connecting portion of said connecting member is connected to said actuator, wherein said lower connecting portion has a diameter that is smaller that a diameter of said upper connecting portion, wherein said reset member is wound around said lower connecting portion of said connecting member.

10. The pet hair trim clipper according to claim 9, wherein said driving element further comprises a guiding member which is a guiding tube for guiding and restricting a sliding movement of said connecting member, wherein said rest member is assembled in said guiding member.

11. The pet hair trim clipper according to claim 3, wherein said main clipper body further comprises a clipper housing, wherein said trim assembly is connected to said clipper housing, wherein an air duct is formed in said main clipper body and said handle, wherein said clipper body has a vacuum adjusting hole communicated to said air duct.

12. The pet hair trim clipper according to claim 11, wherein said hair removing assembly comprises a hair removing element, an actuator, and a driving element, wherein said driving element comprises a connecting member connected to said actuator, and a reset member, wherein said removing element has a vent hole communicated to said air duct and said vent hole is aligned with said vacuum adjusting hole, wherein when said actuator is pressed, said connecting member is driven to move, so as to drive said hair removing element to move with respect to said two longitudinal trim cutters and said vent hole of said hair removing element is moved to a position that is not aligned with said vacuum adjusting hole, wherein when said actuator is released, said reset member reset said actuator, said connecting member and said hair removing element, and said vent hole is restored to be aligned with said vacuum adjusting hole.

13. The pet hair trim clipper according to claim 11, wherein said hair removing assembly further comprises a cover portion having a connecting hole that is aligned with said vent hole, wherein when said actuator is pressed, said cover portion is fitted to said clipper housing to block said vacuum adjusting hole.

14. The pet hair trim clipper according to claim 3, wherein said main clipper body further comprises a clipper housing, wherein said trim assembly is connected to said clipper housing, wherein said hair removing assembly comprises a hair removing element which comprises a hair removing plate having two slots, wherein said clipper housing is configured to be moved to direct said two longitudinal trim cutters to pass through said two slots in said hair removing plate respectively for trimming the pet hair.

15. The pet hair trim clipper according to claim 14, wherein said hair removing element further comprises a supporting sleeve, wherein said clipper housing is slidably coupled to said supporting sleeve in a manner that when said clipper housing is pressed, said clipper housing is driven to slide along an outer side of said supporting sleeve, so as to drive said two longitudinal trim cutters to pass through said two slots in said hair removing plate respectively.

16. The pet hair trim clipper according to claim 3, wherein said main clipper body further comprises a clipper housing connected to said handle for mounting said two longitudinal trim cutters, wherein said hair removing assembly comprises a hair removing element and an actuator which is mounted to said handle, wherein said actuator is pressed to drive said hair removing element to move with respect to said two longitudinal trim cutters for scraping down the hair on said two longitudinal trim cutters.

17. The pet hair trim clipper according to claim 3, further comprising a vacuum machine which comprises a machine body and a connecting pipe, wherein said connecting pipe is detachably connected to said handle.

18. The pet hair trim clipper according to claim 3, further comprising a suction assembly connected to said handle.

19. The pet hair trim clipper according to claim 1, wherein two sets of trimmer members arranged on a front of said main clipper body, a hair removing element which is a plate is arranged on said front of said main clipper body, two sets of slots are formed at a front side of said hair removing element for said trimmer members to pass through said slots, a button slot is formed on a back of said main clipper body, a pressing button is arranged in said button slot, a connecting rod is arranged in said main clipper body, a reset spring is arranged on an outer circumference of said connecting rod, an air duct slot is form at said front side of said main clipper body, a second slot is opened at said front side of said hair removing element.

20. The pet hair trim clipper according to claim 19, wherein said handle is a hollow tube, wherein said second slot is in communication with said air duct slot, said connecting rod passes through said main clipper body and is connected to said hair removing element, and a back of said connecting rod is connected to said pressing button.
